(19) United States
(12) Patent Application Publication
(10) Pub. No.: US 2025/0317346 A1
(43) Pub. Date: Oct. 9, 2025

(54) TUNNEL FAILOVER IN A NETWORK SYSTEM

(71) Applicant: HEWLETT PACKARD ENTERPRISE DEVELOPMENT LP, Spring, TX (US)

(72) Inventors: Pengfei Jin, Beijing (CN); Xiaoding Shang, Beijing (CN); Zhijun Ren, Beijing (CN); Hao Lu, Fremont, CA (US)

(21) Appl. No.: 18/626,975

(22) Filed: Apr. 4, 2024

(51) Int. Cl. H04L 41/0654

(52) U.S. Cl. CPC H04L 41/0654

(57) ABSTRACT

Example implementations relate to recovery from a failed tunnel in a network system. An example includes a medium storing instructions to: establish a first secure tunnel between a first node device to a branch device, where the branch device is connected to a second node device via a second secure tunnel; after a failure of the second secure tunnel, receive a data packet at the first node device from the branch device via the first secure tunnel; and, in response to a determination that the data packet is associated with an existing session established via the second secure tunnel, send the data packet from the first node device to the second node device via a third secure tunnel, where the second node device is to modify the data packet and send the modified data packet to a remote service provider.

### BACKGROUND

Some computing systems may transmit and access information via data networks. A data network may include a group of devices, or “nodes” herein, that are coupled via a communication links. In some examples, each node may include hardware and software components.

### BRIEF DESCRIPTION OF THE DRAWINGS

Some implementations are described with respect to the following figures.

FIG. 1 is a schematic diagram of an example computing system, in accordance with some implementations.

FIG. 2 is an illustration of an example process, in accordance with some implementations.

FIGS. 3A-3E are illustrations of an example operations, in accordance with some implementations.

FIG. 4 is an illustration of an example process, in accordance with some implementations.

FIG. 5 is a diagram of an example machine-readable medium storing instructions in accordance with some implementations.

FIG. 6 is a schematic diagram of an example node device, in accordance with some implementations.

FIG. 7 is a schematic diagram of an example branch device, in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a company or other organization may use a Software-Defined Wide Area Network (SD-WAN) to connect multiple locations or facilities. An SD-WAN may be an overlay architecture that uses routing or switching software to create virtual connections between computing devices (e.g., physical computing devices, virtual machines, or a combination thereof). In some examples, a virtual connection may connect two endpoints, and may be routed through one or more intermediate points (e.g., devices or locations) that are located between the endpoints. For example, a data packet traveling across a virtual connection may originate at a client device (e.g., a desktop computer), may connect through a branch device (e.g., a network device located at a branch office of an organization), may then pass through a secure node (e.g., a secure service edge (SSE) node), and may be delivered to a remote device or network (e.g., an internet-based website or cloud service provider that is in a different physical location than the locations in the SD-WAN). As used herein, the term “node” may refer to an endpoint or an intermediate point in a virtual connection. Further, an encrypted link connecting two or more nodes may be referred to as a “tunnel.” For example, a tunnel may implement an Internet Protocol Secure (IPSec) protocol, a Secure Sockets Layer (SSL) protocol, and so forth.

In some examples, an SD-WAN may provide redundant connections to improve the reliability of the network. For example, a branch device may be connected to a first secure node via a first tunnel, and may be connected to a second secure node via a second tunnel. Each of the first and second nodes may be connected to the remote network. In an example, the second tunnel may be designated as the active data path, and the first tunnel may be designated as a standby (e.g., a failover backup) for the first tunnel. In this example, during normal function, all data packets (sent between the client device and the remote network) will pass through the second secure node via the active second tunnel. However, if the second tunnel fails, all subsequent data packets will pass through the first secure node via the standby first tunnel. In some examples, each secure node may perform source network address translation (SNAT) to modify packets sent from the client device to the service provider. For example, each secure node may replace the internet protocol (IP) address (e.g., in the IP header) of an outbound packet with a public IP address of that secure node.

In some examples, the client device may establish a network session with a service provider (e.g., an internet-based service) using a data path that includes the active second tunnel (e.g., between the branch device and the second secure node). The service provider may record information regarding the session, including a session identifier and session network information (e.g., a source IP address and a source port) for packets received during the session. In particular, because the second secure node is performing a SNAT process on outbound packets, the source IP address (recorded by the service provider) is a public IP address of the second secure node. However, in the event of a failure of the active second tunnel, the data path will failover to using the standby first tunnel connected to the first secure node. Subsequently, a new packet (e.g., associated with the existing session) that is sent from the client device to the service provider will undergo a SNAT process at the first secure node, and thus will be modified to include a public IP address of the first secure node. As such, the service provider may not be able to match the IP address in the new packet to the IP address that was previously recorded for the existing session (e.g., the public IP address of the second secure node), and may thereby erroneously determine that the new packet is associated with a different session (e.g., a new session). Accordingly, the client device may lose the existing session with the service provider, thereby resulting in wasted time, lost data, and so forth.

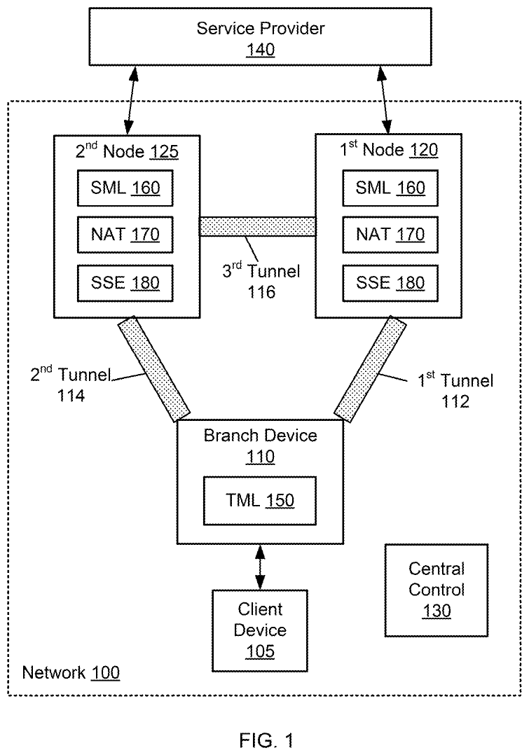

In accordance with some implementations of the present disclosure, a network system may recover from a failed secure network tunnel without loss of an existing session established across the failed tunnel. As discussed further below with reference to FIGS. 1-7, the network system may include a first tunnel between a branch device and a first secure node, a second tunnel between the branch device and a second secure node, and a third tunnel between the first secure node and the second secure node. A client device may initiate a session with a remote service provider using a data path that includes the second tunnel to the second secure node. Subsequently, upon detecting a failure of the second tunnel, the branch device may failover (i.e., switch) to using the first tunnel to communicate with the service provider. When the client device sends a new packet (e.g., associated with the existing session) to the service provider, the branch device may modify the packet to include a previous session indicator (e.g., a flag, encapsulation, and so forth) to indicate that the packet is associated with the existing session, and may forward the packet to the first secure node (via the first tunnel). Upon receiving the packet with the previous session indicator, the first secure node may forward the packet to the second secure node via the third tunnel. The second secure node may then perform the SNAT process to include a public IP address of the second secure node. The service provider may then match the IP address in the new packet to the IP address that was previously recorded for the existing session, and may thereby allow the client device to continue using the existing session. In this manner, some implementations may allow recovery from the loss of the primary tunnel, but without the loss of the availability of the existing session.

### FIG. 1—Example Network System

FIG. 1 shows an example of a network system 100, in accordance with some implementations. The network system 100 may include any number and type of network devices, including a client device 105, a branch device 110, a first node 120, a second node 125, and a central control 130. Some or all of the network devices (i.e., devices 105, 110, 120, 125, 130) may be physical and/or virtual devices, including compute nodes, storage devices, or components thereof. In some implementations, the client device 105 may be a computing device or host (e.g., a computer server including a processor, memory, and persistent storage). The branch device 110 may be a network access device (e.g., a wireless access point or router), and may be located at a particular location or building (e.g., a branch office of an organization, a home office, a retail outlet, and so forth). In some implementations, the branch device 110 may function as an endpoint of one or more secure tunnels (e.g., tunnel(s) implementing an IPSec protocol, an SSL protocol, and so forth).

In some implementations, the nodes 120, 125 may be network devices or services that receive data packets, and forward the data packets to destination address(es). For example, the nodes 120, 125 may include gateway devices (e.g., secure service edge (SSE) nodes) that allows components of the network 100 (e.g., client device 105) to communicate with a service provider 140 that is external to the network 100. In some implementations, each of the nodes 120, 125 may function as an endpoint of one or more secure tunnels.

In some implementations, the service provider 140 may be a website or network device that is accessed via the internet, or via another network that is remote from (e.g., having a different physical location than) the network system 100. Further, the service provider 140 may provide specific service(s) to the client device 105. For example, the service provider 140 may be a commercial website, a banking service, a data storage service, a video-conferencing service, a software as a service (SaaS) provider, and so forth. In some implementations, the client device 105 may establish a network session with the service provider 140. The network session may be a time-delimited stateful interaction between the service provider 140 and the client device 105. For example, during a session for a commercial transaction, the service provider 140 may store current state information of the session (e.g., data inputs received in various messages) that are necessary to complete the commercial transaction.

In some implementations, the nodes 120, 125 may each include a network address translation (NAT) engine 170. The NAT engine 170 may translate IP addresses of data packets that are forwarded by the nodes 120, 125. For example, in the case of an outbound packet (e.g., sent from client device 105 to service provider 140), the NAT engine 170 in the second node 125 may perform source network address translation (SNAT) to replace the private IP address (e.g., the IP address of the client device 105 in the network 100) in the outbound packet with a public IP address of the second node 125. The NAT engine 170 may also change the source port in the packet header(s) (e.g., in transmission control protocol (TCP) and/or user datagram protocol (UDP) headers). In another example, in the case of an inbound packet (e.g., sent from service provider 140 to client device 105), the NAT engine 170 in the second node 125 may perform destination network address translation (DNAT) to replace a public IP address (e.g., for the second node 125) in the inbound packet with the private IP address of the client device 105.

In some implementations, each of the nodes 120, 125 may include a secure service edge (SSE) engine 180. The SSE engine 180 may provide security capabilities (e.g., encryption, authentication, etc.) to data packets that are received and forwarded by the nodes 120, 125. Further, in some implementations, the SSE engine 180 may also provide access control, threat protection, security monitoring, and/or acceptable-use control. Other examples are possible.

In some implementations, the branch device 110 may be connected to the first node 120 via a first tunnel 112. The branch device 110 may be connected to the second node 125 via a second tunnel 114. Further, the first node 120 may be connected to the second node 125 via a third tunnel 116. The tunnels 112, 114, 116 may include security capabilities to protect any data that is transferred across the tunnels 112, 114, 116. For example, the tunnels 112, 114, 116 may implement an IPSec protocol, an SSL protocol, and so forth. In some implementations, the central control 130 may provide management and configuration of the network system 100. For example, the central control 130 may be a cloud-based device or service that provides design and configuration of the tunnels 112, 114, 116 (e.g., specifying the endpoints of each tunnel, configuring the security protocol of each tunnel, and so forth).

In some implementations, the branch device 110 may include tunnel management logic (TML) 150. Further, each of the nodes 120, 125 may include session management logic (SML) 160. The TML 150 and the SML 160 may function in combination to provide recovery from tunnel failure in the network system 100. In an example, the TML 150 initially selects the second tunnel 114 as the primary or “active” tunnel that transmits, to the second node 125, packets for a session between the client device 105 and the service provider 140. In some implementations, the SML 160 of the second node 125 may detect the establishment of the session between the client device 105 and the service provider 140, and in response may record session information in a data structure (e.g., a session table) stored in the second node 125. For example, such session information may include a source IP address, a destination IP address, port identifier(s), device identifier(s), time stamp(s), protocol type(s), and so forth. Further, the TML 150 may record session information (e.g., in a data structure stored in the branch device 110) indicating that the second tunnel 114 is the active tunnel for the established session between the client device 105 and the service provider 140.

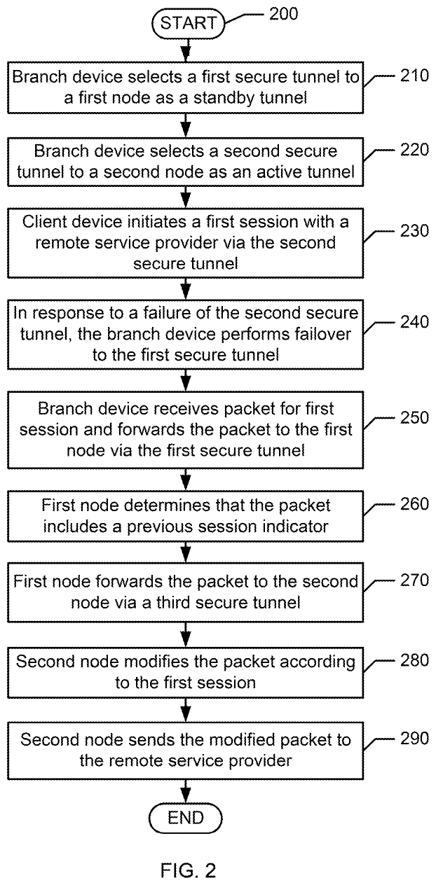

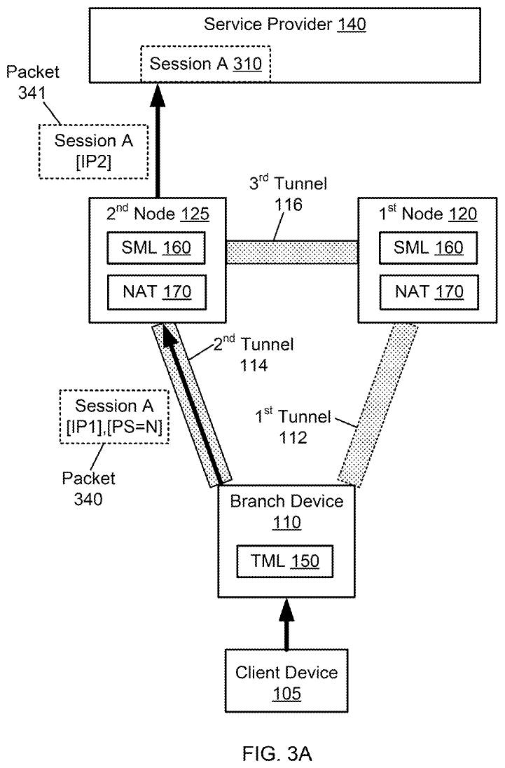

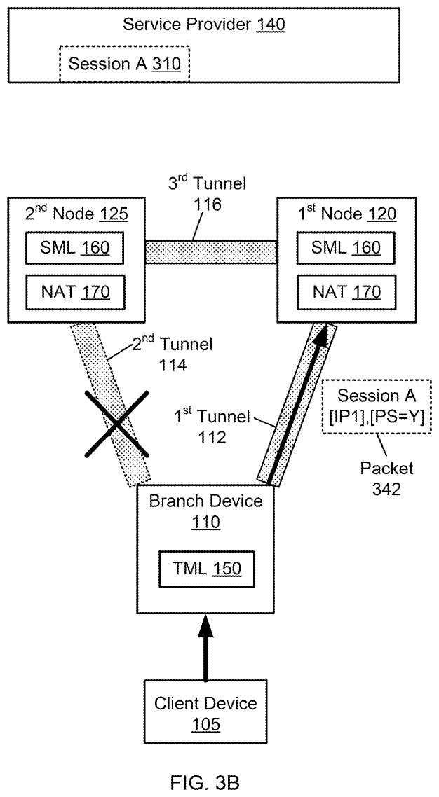

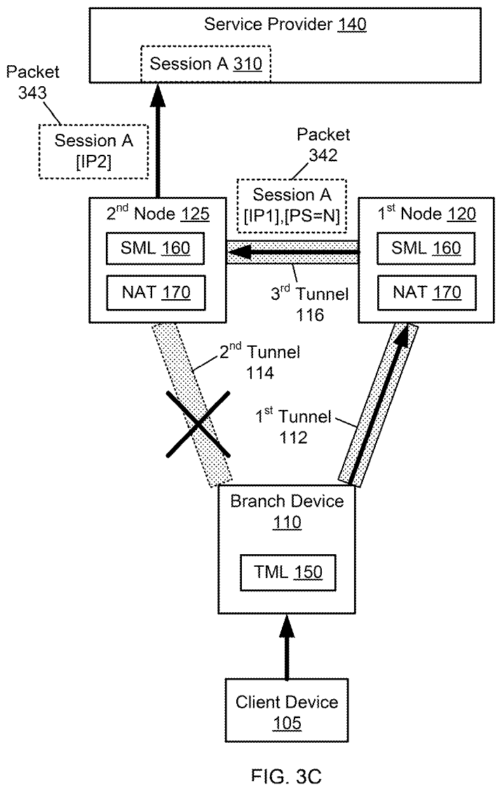

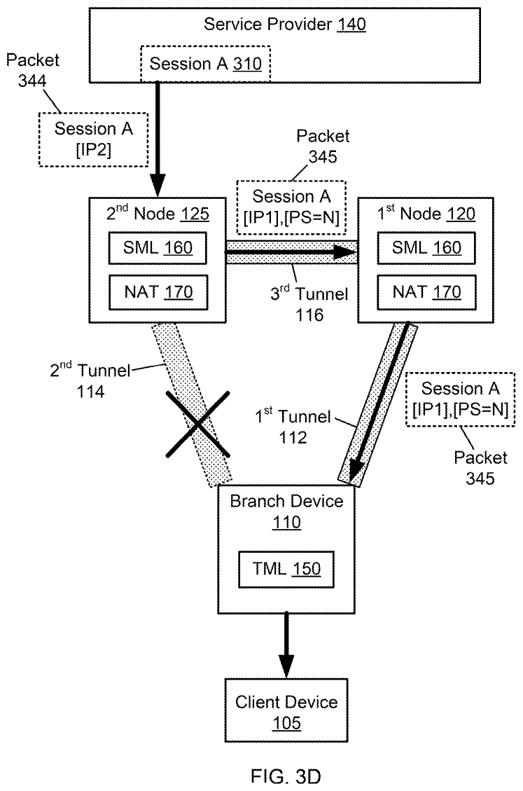

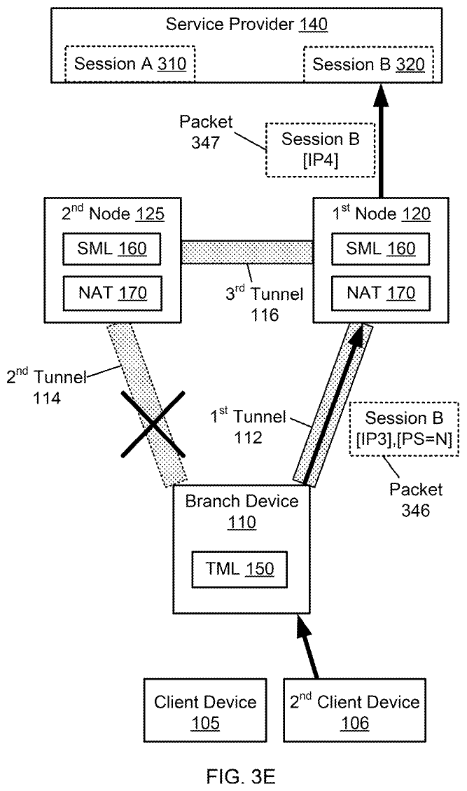

In some implementations, after selecting and using the second tunnel 114 as the active tunnel, the TML 150 (in branch device 110) may detect a failure of the second tunnel 114 (e.g., due to a software or hardware error), and in response may perform a failover to use the first tunnel 112 as the active tunnel. Further, when the branch device 100 receives a packet from the client device 105, the TML 150 determines whether the packet is associated with the existing session that was established using the second tunnel 114 (e.g., using session information stored in branch device 110). If it is determined that the packet is associated with the existing session, the TML 150 modifies the packet to include a previous session flag indicating that the packet is associated with the existing session, and may forward the packet to the first node 120 via the first tunnel 112. Upon receiving the packet, the SML 160 of the first node 120 forwards the packet to the second node 125 via the third tunnel 116. The second node 125 may match the packet to the session information recorded for the existing session (e.g., using session information stored in the second node 125), may modify the packet by performing a SNAT process (e.g., to replace the IP address of the client device 105 with a public IP address of the second node 125), and may forward the modified packet to the service provider 140. The service provider 140 may then match the IP address in the new packet to the IP address that was previously recorded for the existing session (e.g., using session information stored by the service provider 140), and may thereby allow the client device 105 to continue using the existing session. A process for recovery from tunnel failure in the network system (e.g., performed by the TML 150 and the SML 160) is described further below with reference to FIGS. 2 and 3A-3E.

Note that, while FIG. 1 shows an example network system 100, implementations are not limited in this regard. For example, it is contemplated that the network system 100 may include any number of client devices, nodes, branch devices, tunnels, service providers, and so forth. Further, the network system 100 may include additional devices and/or components, fewer components, different components, different arrangements, and so forth. In another example, it is contemplated that the functionality of the TML 150 and/or the SML 160 described above may be included in any another engine or software of the network system 100. Other combinations and/or variations are also possible. Some or all of the network devices (i.e., devices 105, 110, 120, 125, 130) may be implemented via one or more controllers. A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

FIGS. 2 and 3A-3E—Example Process for Recovery from Tunnel Failure

FIG. 2 shows is an example process 200 for recovery from tunnel failure in the network system, in accordance with some implementations. The process 200 may be implemented in hardware or a combination of hardware and programming (e.g., machine-readable instructions executable by a processor(s) and/or controller(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 200 may be described below with reference to FIGS. 1 and 3A-3E, which show example implementations. However, other implementations are also possible.

Referring to FIG. 2, block 210 may include a branch device selecting a first secure tunnel to a first node as a standby tunnel. Block 220 may include the branch device selecting a second secure tunnel to a second node as an active tunnel. For example, referring to FIG. 1, the branch device 110 includes a tunnel management logic (TML) 150 that selects the second tunnel 114 as an active tunnel to transmit all (or a majority) of traffic from the branch device 110 to an external network (e.g., packets sent to/from the service provider 140). Further, the TML 150 selects the first tunnel 112 as a standby tunnel that can act as a backup or failover for the second tunnel 114. The TML 150 may record session information indicating that the second tunnel 114 is the active tunnel for the established session.

Referring again to FIG. 2, block 230 may include a client device initiating a first session with a remote service provider via the second secure tunnel. For example, referring to FIG. 3A, the client device 105 establishes a session “A” with the service provider 140. In the example illustrated in FIG. 3A, a packet 340 is sent from the client device 105 to the branch device 110, and is then routed via the second tunnel 114 to the second node 125. As shown, the packet 340 is associated with session “A,” includes the IP address “IP1,” and includes a previous session (PS) flag set to a negative value (“PS=N”). For example, the IP address “IP1” may be a private IP address of the client device 105. In some implementations, the session management logic (SML) the SML 160 of the second node 125 may detect the establishment of the session between the client device 105 and the service provider 140, and may record session information in a data structure (e.g., a session table) stored in the second node 125. For example, a session table of the second node 125 may record the second tunnel 114 as the ingress tunnel for the established session.

In some implementations, the network address translation (NAT) engine 170 in the second node 125 modifies the packet 340 (e.g., by performing source network address translation) to generate a modified packet 341 that is sent to the service provider 140. The modified packet 341 includes the IP address “IP2” (e.g., a public IP address of the second node 125). Further, in some implementations, the SML 160 of the second node 125 removes the previous session (PS) flag from the modified packet 341. In some implementations, the service provider 140 stores session data 310 associated with the session “A” with the client device 105. For example, the session data 310 may store the IP address “IP2” as an identifier for the session “A” with the client device 105. Subsequently, upon receiving other packets, the service provider 140 may determine whether the IP address of the packets match the IP address “IP2” stored in the session data 310. If a match is found, the service provider 140 determines that the matching packet corresponds to session “A.”

Referring again to FIG. 2, block 240 may include, in response to a failure of the second secure tunnel, the branch device performing a failover to the first secure tunnel. Block 250 may include the branch device receiving a packet for the first session and forwarding the packet to the first node via the first secure tunnel. For example, referring to FIG. 3B, the TML 150 of the branch device 110 detects a failure of the second tunnel 114, and in response performs a failover to use the first tunnel 112 as the active tunnel. Subsequently, the branch device 110 receives another packet 342 from client device 105, and determines that the packet 342 is associated with the session “A” that was previously established using the second tunnel 114 (e.g., using session information stored in branch device 110). The TML 150 sets the previous session flag of packet 342 set to a positive value (“PS=Y”) (e.g., indicating that the packet 342 is associated with a previous session), and then forwards the packet 342 to the first node 120 via the first tunnel 112.

Referring again to FIG. 2, block 260 may include the first node determining that the packet includes a previous session indicator. Block 270 may include the first node forwarding the packet to the first node via a third secure tunnel. Block 280 may include the second node modifying the packet according to the first session. Block 290 may include the second node sending the modified packet to the remote service provider. For example, referring to FIG. 3C, the session management logic (SML) 160 of the first node 120 determines that the previous session flag of packet 342 is set to a positive value (“PS=Y”), and thereby determines that the packet 342 is associated with a previous session. In some implementations, the SML 160 of the first node 120 sets the previous session flag of packet 342 to a negative value (“PS=N”), and then forwards the packet 342 to the second node 125 via the third tunnel 116. The second node 125 matches the packet 342 to the session information recorded for the existing session (e.g., using a session table). The second node 125 modifies the packet 342 to generate a modified packet 343, and then sends the modified packet 343 to the service provider 140. For example, generating the modified packet 343 may include replacing, via the NAT engine 170 of the second node 125, the IP address “IP1” (e.g., a private IP address of the client device 105) with the IP address “IP2” (e.g., a public IP address of the second node 125). In some implementations, the second node 125 may update the session information recorded for the existing session to change the ingress tunnel from the second tunnel 114 to the third tunnel 116. Further, in some implementations, the SML 160 of the second node 125 may remove the previous session (PS) flag from the modified packet 343. Upon receiving the modified packet 343, the service provider 140 determines that the IP address “IP2” in the modified packet 343 matches the IP address “IP2” stored in the session data 310, and thereby determines that the modified packet 343 corresponds to session “A.”

In some implementations, the previous session indicator may be a flag or field included in the packet 342, or in an encapsulation header of the packet 342. For example, the previous session indicator may be a non-zero value stored in a subset of the bits (e.g., the lowest eight bits) in a Security Parameter Index (SPI) identifier included in an IPSec encapsulation header of the packet 342. In other implementations, the previous session indicator may be an encapsulation type for the packet 342 (e.g., a particular encapsulation type of IPSec that is applied to a header of the packet 342). Other implementations of the previous session indicator are possible. In some implementations, after evaluating the previous session indicator of the packet 342 (e.g., at box 260), the SML 160 of the first node 120 may remove the previous session indicator before forwarding the packet 342 to the second node 125 via the third tunnel 116.

Referring now to FIG. 3D, the service provider 140 sends a reply packet 344 (e.g., a response to the modified packet 343 shown in FIG. 3C) to the second node 125. The second node 125 matches the reply packet 344 to the session information recorded for the existing session (e.g., using a session table). The second node 125 modifies the reply packet 344 to generate a modified packet 345. For example, generating the modified packet 345 may include replacing, via the NAT engine 170 of the second node 125, the IP address “IP2” with the IP address “IP1.” In some implementations, the second node 125 uses an internal session table to determine that the ingress tunnel (e.g., in a path from client 105 to service provider 140) from the second node 125 is the third tunnel 116. Accordingly, the second node 125 may send the modified packet 345 to the first node 120 via the third tunnel 116. In some implementations, the modified packet 345 may include a previous session indicator set to a negative value (“PS=N”). The first node 120 then sends the modified packet 345 to the branch device 110 via the first tunnel 112. The branch device 110 sends the modified packet 345 to the client device 105. In some implementations, the branch device 110 may remove the previous session indicator from the packet 345 that is sent to the client device 105.

Referring now to FIG. 3E, a second client device 106 sends a packet 346 to be delivered to the service provider 140. Upon receiving the packet 346, the TML 150 of branch device 110 determines that the packet 346 is not associated with any existing session (e.g., existing session “A”) based on session information (e.g., stored in branch device 110). Accordingly, the previous session flag of the packet 346 is set to (or allowed to remain as) a negative value (“PS=N”) by the TML 150.

As shown in FIG. 3E, the packet 346 is associated with session “B” (established between the second client device 106 and the service provider 140) and includes the IP address “IP3.” In some implementations, the SML 160 of the first node 120 determines that the previous session flag of the packet 346 is set to a negative value (“PS=N”), and therefore determines that the packet 346 is not associated with a previous session (e.g., previous session “A”), but rather is associated with a new session (e.g., new session “B”). In response to this determination, the SML 160 of the first node 120 modifies the packet 346 to generate a modified packet 347 that is sent from the first node 120 to the service provider 140 as part of session “B.” For example, generating the modified packet 347 may include replacing, via the NAT engine 170 of the first node 120, the IP address “IP3” (e.g., a private IP address of the second client device 106) with the IP address “IP4” (e.g., a public IP address of the first node 120). Further, in some implementations, the SML 160 of the first node 120 may remove the previous session (PS) flag from the modified packet 347.

In some implementations, the service provider 140 stores session data 320 associated with the session “B” with the second client device 106. For example, the session data 320 may store the IP address “IP4” as an identifier for the session “B” with the second client device 106. Subsequently, upon receiving other packets, the service provider 140 may determine whether the IP address of the packets match the IP address “IP4” stored in the session data 320. If so, the service provider 140 determines that the matching packet corresponds to session “B.” Note that, while FIG. 3E illustrates an example in which the session “B” is established between the second client device 106 and the service provider 140, implementations are not limited in this regard. For example, it is contemplated that the session “B” may be a different session established between the client device 105 and the service provider 140 (e.g., established by a different user of the client device 105).

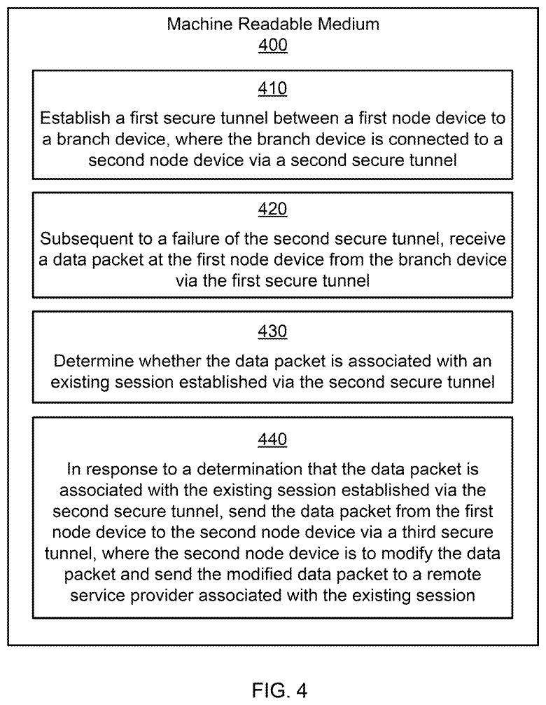

### FIG. 4—Example Machine-Readable Medium

FIG. 4 shows a machine-readable medium 400 storing instructions 410-440, in accordance with some implementations. The instructions 410-440 can be executed by a single processor, multiple processors, a single processing engine, multiple processing engines, and so forth. The machine-readable medium 400 may be a non-transitory storage medium, such as an optical, semiconductor, or magnetic storage medium.

Instruction 410 may be executed to establish a first secure tunnel between a first node device to a branch device, where the branch device is connected to a second node device via a second secure tunnel. For example, referring to FIG. 3A, the branch device 110 includes a tunnel management logic (TML) 150 that selects the second tunnel 114 as an active tunnel, and selects the first tunnel 112 as a standby tunnel that can act as a failover for the second tunnel 114. The client device 105 establishes a session “A” with the service provider 140. A session packet 340 (i.e., a packet associated with session “A”) is sent from the client device 105 to the branch device 110, and is then routed via the second tunnel 114 to the second node 125.

Instruction 420 may be executed to, subsequent to a failure of the second secure tunnel, receive a data packet at the first node device from the branch device via the first secure tunnel. For example, referring to FIG. 3B, the TML 150 of the branch device 110 detects a failure of the second tunnel 114, and in response performs a failover to use the first tunnel 112 as the active tunnel. Subsequently, the branch device 110 receives another packet 342 from client device 105, and determines that the packet 342 is associated with the session “A” that was previously established using the second tunnel 114. The TML 150 sets the previous session flag of packet 342 set to a positive value (“PS=Y”) (e.g., indicating that the packet 342 is associated with a previous session), and then forwards the packet 342 to the first node 120 via the first tunnel 112 (i.e., the currently-active tunnel).

Instruction 430 may be executed to determine whether the data packet is associated with an existing session established via the second secure tunnel. Instruction 440 may be executed to, in response to a determination that the data packet is associated with the existing session established via the second secure tunnel, send the data packet from the first node device to the second node device via a third secure tunnel, where the second node device is to modify the data packet and send the modified data packet to a remote service provider associated with the existing session. For example, referring to FIG. 3C, the session management logic (SML) 160 of the first node 120 determines that the previous session flag of packet 342 is set to a positive value (“PS=Y”), and in response forwards the packet 342 to the second node 125 via the third tunnel 116. The second node 125 then modifies the packet 342 to generate a modified packet 343 that is sent to the service provider 140. For example, generating the modified packet 343 may include replacing, via the NAT engine 170 of the second node 125, the IP address “IP1” (e.g., a private IP address of the client device 105) with the IP address “IP2” (e.g., a public IP address of the second node 125). Further, generating the modified packet 343 may include removing, by the SML 160 of the second node 125, the previous session flag of modified packet 343. Upon receiving the modified packet 343, the service provider 140 determines that the IP address “IP2” in the modified packet 343 matches the IP address “IP2” stored in the session data 310, and thereby determines that the modified packet 343 corresponds to session “A.”

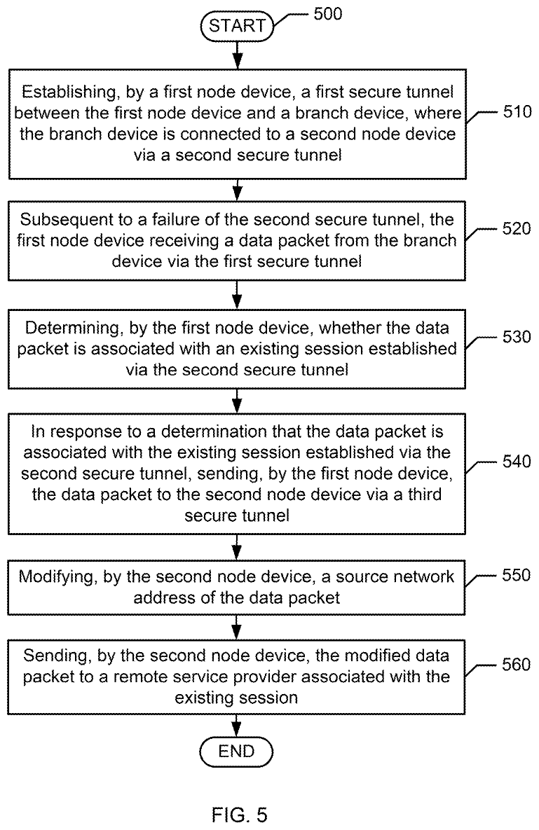

FIG. 5—Example Process for Recovery from Tunnel Failure

FIG. 5 shows is an example process 500 for recovery from tunnel failure in the network system, in accordance with some implementations. The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. For the sake of illustration, details of the process 200 may be described below with reference to FIGS. 1 and 3A-3E, which show example implementations. However, other implementations are also possible.

Block 510 may include establishing, by a first node device, a first secure tunnel between the first node device and a branch device, where the branch device is connected to a second node device via a second secure tunnel. Block 520 may include, subsequent to a failure of the second secure tunnel, the first node device receiving a data packet from the branch device via the first secure tunnel.

Block 530 may include determining, by the first node device, whether the data packet is associated with an existing session established via the second secure tunnel. Block 540 may include, in response to a determination that the data packet is associated with the existing session established via the second secure tunnel, sending, by the first node device, the data packet to the second node device via a third secure tunnel.

Block 550 may include modifying, by the second node device, a source network address of the data packet. Block 560 may include sending, by the second node device, the modified data packet to a remote service provider associated with the existing session. Blocks 510-560 may correspond generally to the examples described above with reference to instructions 410-440 (shown in FIG. 4).

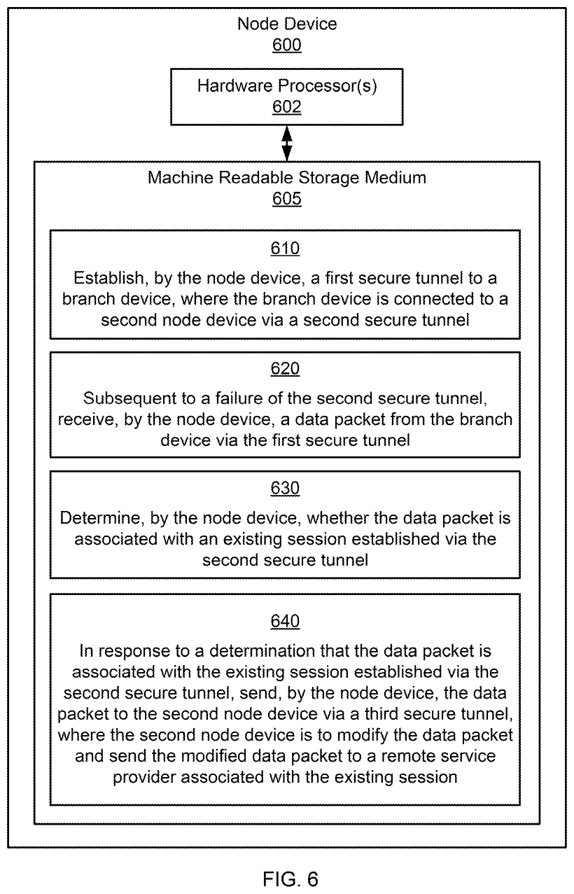

### FIG. 6—Example Node Device

FIG. 6 shows a schematic diagram of an example node device 600. In some examples, the node device 600 may correspond generally to one of the nodes 120, 125 included in the network system 100 (shown in FIGS. 1 and 3A-3E). In some implementations, the node device 600 may be a network device or service that receives data packets, and then forwards the data packets to a destination address. For example, the node device 600 may include a gateway device (e.g., a secure service edge (SSE) node) that allows components of a network to communicate with a service provider that is external to the network. In some implementations, the node device 600 may function as an endpoint of one or more secure tunnels (e.g., tunnel(s) implementing an IPSec protocol, an SSL protocol, and so forth).

As shown, the computing device 600 may include a hardware processor 602, a memory 604, and machine-readable storage 605 including instructions 610-640. The machine-readable storage 605 may be a non-transitory medium. The instructions 610-640 may be executed by the hardware processor 602, or by a processing engine included in hardware processor 602. The instructions 610-640 may correspond generally to the examples described above with reference to instructions 410-440 (shown in FIG. 4).

Instruction 610 may be executed to establish, by the node device, a first secure tunnel to a branch device, where the branch device is connected to a second node device via a second secure tunnel. Instruction 620 may be executed to, subsequent to a failure of the second secure tunnel, receive, by the node device, a data packet from the branch device via the first secure tunnel.

Instruction 630 may be executed to determine, by the node device, whether the data packet is associated with an existing session established via the second secure tunnel. Instruction 640 may be executed to, in response to a determination that the data packet is associated with the existing session established via the second secure tunnel, send, by the node device, the data packet from the first node device to the second node device via a third secure tunnel, where the second node device is to modify the data packet and send the modified data packet to a remote service provider associated with the existing session.

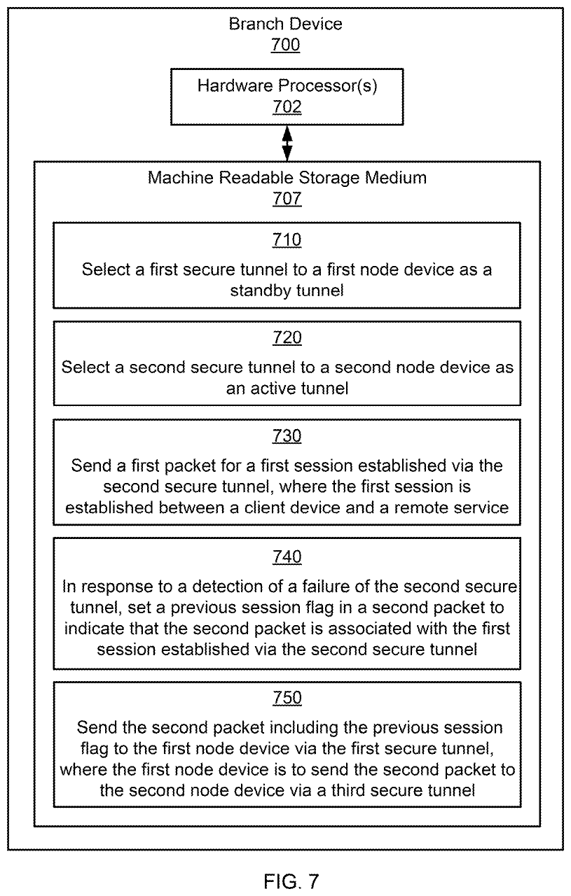

### FIG. 7—Example Branch Device

FIG. 7 shows a schematic diagram of an example branch device 700. In some examples, the branch device 700 may correspond generally to the branch device 110 included in the network system 100 (shown in FIG. 1). In some examples, the branch device 700 may be a network access device (e.g., a wireless access point or router). Further, in some examples, the branch device 700 may be located at a particular location or building (e.g., a branch office of an organization, a home office, a retail outlet, and so forth). In some implementations, the branch device 700 may function as an endpoint of one or more secure tunnels (e.g., tunnel(s) implementing an IPSec protocol, an SSL protocol, and so forth). As shown, the branch device 700 may include a hardware processor 702, a memory 704, and machine-readable storage 705 including instructions 710-750. The machine-readable storage 705 may be a non-transitory medium.

Instruction 710 may be executed to select a first secure tunnel to a first node device as a standby tunnel. Instruction 720 may be executed to select a second secure tunnel to a second node device as an active tunnel. Instruction 730 may be executed to send a first packet for a first session established via the second secure tunnel, where the first session is established between a client device and a remote service. For example, referring to FIG. 3A, the branch device 110 includes a tunnel management logic (TML) 150 that selects the second tunnel 114 as an active tunnel, and selects the first tunnel 112 as a standby tunnel that can act as a failover for the second tunnel 114. The client device 105 establishes a session “A” with the service provider 140. A session packet 340 (i.e., a packet associated with session “A”) is sent from the client device 105 to the branch device 110. The branch device 110 then sends the packet via the second tunnel 114 to the second node 125.

Instruction 740 may be executed to, in response to a detection of a failure of the second secure tunnel, set a previous session flag in a second packet to indicate that the second packet is associated with the first session established via the second secure tunnel. Instruction 750 may be executed to send the second packet including the previous session flag to the first node device via the first secure tunnel, where the first node device is to send the second packet to the second node device via a third secure tunnel. For example, referring to FIG. 3B, the TML 150 of the branch device 110 detects a failure of the second tunnel 114, and in response performs a failover to use the first tunnel 112 as the active tunnel. Subsequently, the branch device 110 receives another packet 342 from client device 105, and determines that the packet 342 is associated with the session “A” that was previously established using the second tunnel 114. The TML 150 sets the previous session flag of packet 342 set to a positive value (“PS=Y”) (e.g., indicating that the packet 342 is associated with a previous session), and then forwards the packet 342 to the first node 120 via the first tunnel 112 (i.e., the currently-active tunnel). Referring now to FIG. 3C, the session management logic (SML) 160 of the first node 120 determines that the previous session flag of packet 342 is set to a positive value (“PS=Y”), and in response forwards the packet 342 to the second node 125 via the third tunnel 116. The second node 125 then modifies the packet 342 to generate a modified packet 343 that is sent to the service provider 140.

In accordance with implementations described herein, a network system may recover from a failed secure network tunnel without loss of an existing session established across the failed tunnel. The network system may include a first tunnel between a branch device and a first secure node, a second tunnel between the branch device and a second secure node, and a third tunnel between the first secure node and the second secure node. A client device may initiate a session with a remote service provider using a data path that includes the second tunnel to the second secure node. Subsequently, upon detecting a failure of the second tunnel, the branch device may failover to using the first tunnel to communicate with the service provider. When the client device sends a new session packet to the service provider, the branch device may modify the packet to include a previous session indicator or flag to indicate that the packet is associated with the existing session, and may send the packet to the first secure node via the first tunnel. Upon receiving the packet with the previous session indicator, the first secure node may send the packet to the second secure node via the third tunnel. The second secure node may then perform the SNAT process to include a public IP address of the second secure node. The service provider may then match the IP address in the new packet to the IP address that was previously recorded for the existing session, and may thereby allow the client device to continue using the existing session. In this manner, some implementations may allow recovery from the loss of the primary tunnel, but without the loss of the availability of the existing session.

Note that, while FIGS. 1-7 show various examples, implementations are not limited in this regard. For example, referring to FIG. 1, it is contemplated that the network system 100 may include additional devices and/or components, fewer components, different components, different arrangements, and so forth. In another example, it is contemplated that the functionality of the branch device 110 and/or the node devices 120, 125 described above may be included in any another engine or software of network system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A node device comprising:
a processor;
a memory; and
a machine-readable storage storing instructions, the instructions executable by the processor to:
establish, by the node device, a first secure tunnel to a branch device, wherein the branch device is connected to a second node device via a second secure tunnel;
subsequent to a failure of the second secure tunnel, receive, by the node device, a data packet from the branch device via the first secure tunnel;
determine, by the node device, whether the data packet is associated with an existing session established via the second secure tunnel; and
in response to a determination that the data packet is associated with the existing session established via the second secure tunnel, send, by the node device, the data packet to the second node device via a third secure tunnel, wherein the second node device is to modify the data packet and send the modified data packet to a remote service provider associated with the existing session.

2. The node device of claim 1, including instructions executable by the processor to:
read a previous session indicator of the data packet; and
determine that the data packet is associated with the existing session in response to a determination that the previous session indicator is set to a positive value.

3. The node device of claim 2, wherein the previous session indicator is one selected from:
a flag in an encapsulation header of the data packet; and
a type of encapsulation of the data packet.

4. The node device of claim 2, including instructions executable by the processor to:
prior to sending the data packet to the second node device via the third secure tunnel, change, by the node device, the previous session indicator to a negative value.

5. The node device of claim 1, including instructions executable by the processor to:
subsequent to the failure of the second secure tunnel, receive, by the node device, a second data packet from the branch device via the first secure tunnel;
in response to a determination that the second data packet is not associated with the existing session established via the second secure tunnel:
modify, by the node device, the second data packet; and
send, by the node device, the modified second data packet to a remote service provider, wherein the modified second data packet is not routed through the second node device, and wherein the remote service provider is to establish a new session based on the modified second data packet.

6. The node device of claim 5, including instructions executable by the processor to:
modify, by the node device, the second data packet by replacing a source network address of the second data packet with a public network address of the node device.

7. The node device of claim 6, wherein:
the data packet is sent by a first client device;
the second data packet is sent by a second client device;
the source network address of the second data packet is a private network address of the second client device; and
the branch device is a network access point for the first client device and the second client device.

8. A method comprising
establishing, by a first node device, a first secure tunnel between the first node device and a branch device, wherein the branch device is connected to a second node device via a second secure tunnel;
subsequent to a failure of the second secure tunnel, the first node device receiving a data packet from the branch device via the first secure tunnel;
determining, by the first node device, whether the data packet is associated with an existing session established via the second secure tunnel; and
in response to a determination that the data packet is associated with the existing session established via the second secure tunnel, sending, by the first node device, the data packet to the second node device via a third secure tunnel.

9. The method of claim 8, further comprising:
modifying, by the second node device, a source network address of the data packet; and
sending, by the second node device, the modified data packet to a remote service provider associated with the existing session.

10. The method of claim 8, further comprising:
reading a previous session indicator of the data packet;
determining whether the previous session indicator is set to a positive value; and
determining that the data packet is associated with the existing session in response to a determination that the previous session indicator is set to the positive value.

11. The method of claim 10, further comprising:
prior to sending the data packet to the second node device via the third secure tunnel, changing, by the first node device, the previous session indicator to a negative value.

12. The method of claim 8, further comprising:
subsequent to the failure of the second secure tunnel, receiving, by the first node device, a second data packet from the branch device via the first secure tunnel;
determining, by the first node device, whether the second data packet is associated with the existing session established via the second secure tunnel;
in response to a determination that the second data packet is not associated with the existing session established via the second secure tunnel:
modifying, by the node device, the second data packet; and
sending, by the node device, the modified second data packet to a remote service provider, wherein the modified second data packet is not routed through the second node device, and wherein the remote service provider is to establish a new session based on the modified second data packet.

13. The method of claim 12, further comprising:
modifying, by the node device, the second data packet by replacing a source network address of the second data packet with a public network address of the node device.

14. The method of claim 13, wherein:
the data packet is sent by a first client device;
the second data packet is sent by a second client device;
the source network address of the second data packet is a private network address of the second client device; and
the branch device is a network access point for the first client device and the second client device.

15. A non-transitory machine-readable medium storing instructions that upon execution cause a processor to:
establish a first secure tunnel between a first node device to a branch device, wherein the branch device is connected to a second node device via a second secure tunnel;
subsequent to a failure of the second secure tunnel, receive a data packet at the first node device from the branch device via the first secure tunnel;
determine whether the data packet is associated with an existing session established via the second secure tunnel; and
in response to a determination that the data packet is associated with the existing session established via the second secure tunnel, send the data packet from the first node device to the second node device via a third secure tunnel, wherein the second node device is to modify the data packet and send the modified data packet to a remote service provider associated with the existing session.

16. The non-transitory machine-readable medium of claim 15, including instructions that upon execution cause the processor to:
read a previous session indicator of the data packet; and
determine that the data packet is associated with the existing session in response to a determination that the previous session indicator is set to a positive value.

17. The non-transitory machine-readable medium of claim 16, including instructions that upon execution cause the processor to:
prior to sending the data packet to the second node device via the third secure tunnel, change, by the first node device, the previous session indicator to a negative value.

18. The non-transitory machine-readable medium of claim 15, including instructions that upon execution cause the processor to:
subsequent to the failure of the second secure tunnel, receive, by the first node device, a second data packet from the branch device via the first secure tunnel;
in response to a determination that the second data packet is not associated with the existing session established via the second secure tunnel:
modify, by the first node device, the second data packet; and
send, by the first node device, the modified second data packet to a remote service provider, wherein the modified second data packet is not routed through the second node device, and wherein the remote service provider is to establish a new session based on the modified second data packet.

19. The non-transitory machine-readable medium of claim 18, including instructions that upon execution cause the processor to:
modify, by the first node device, the second data packet by replacing a source network address of the second data packet with a public network address of the node device.

20. The non-transitory machine-readable medium of claim 19, wherein:
the data packet is sent by a first client device;
the second data packet is sent by a second client device;
the source network address of the second data packet is a private network address of the second client device; and
the branch device is a network access point for the first client device and the second client device.
